(19) United States
(12) Patent Application Publication
(10) Pub. No.: US 2024/0402883 A1
(43) Pub. Date: Dec. 5, 2024

(54) INFORMATION PROCESSING METHOD, APPARATUS, DEVICE, AND COMPUTER MEDIUM

(71) Applicant: Beijing Zitiao Network Technology Co., Ltd., Beijing (CN)

(72) Inventor: Danni WU, Beijing (CN)

(21) Appl. No.: 18/731,140

(22) Filed: May 31, 2024

(30) Foreign Application Priority Data
May 31, 2023 (CN) 202310639638.9

(51) Int. Cl. G06F 3/0482; G06F 3/0484; G06Q 10/1093

(52) U.S. Cl. CPC G06F 3/0482; G06F 3/0484; G06Q 10/1097

(57) ABSTRACT

The disclosure discloses an information processing method, apparatus, device, and computer medium. The method includes: in response to an operation of a first user for viewing first detail information of a task list, displaying a list detail page containing the first detail information, the first detail information including a list of tasks contained in the task list; in response to an operation of the first user for subscribing to the task list, displaying a subscription panel configured for the first user to set a first subscription rule with respect to second detail information of the task list, the first subscription rule comprising a recipient of the second detail information; the recipient comprising a single contact and/or a group, and the second detail information comprising progress information of target tasks in the task list; and pushing the second detail information to the recipient based on the first subscription rule.

### FIELD

The present application belongs to the field of information processing, and in particular, relates to an information processing method, apparatus, device and computer medium.

### BACKGROUND

In related art, in the use scenario of office software, when a user needs to view tasks in a task list, the user needs to tap each task one by one to view the completion status of the task as well as the deadline, which is more complicated to operate and wastes too much time, and thus the efficiency of the user in obtaining information about the task is lower.

### SUMMARY

The embodiments of the present application provide an implementation solution different from that of the related art, so as to solve the technical problem in the related art that the efficiency of the user in obtaining task information is low.

In a first aspect, the present application provides an information processing method including:
in response to an operation of a first user for viewing first detail information of a task list, displaying a list detail page containing the first detail information, the first detail information comprising a list of tasks contained in the task list;
in response to an operation of the first user for subscribing to the task list, displaying a subscription panel, the subscription panel being configured for the first user to set a first subscription rule with respect to second detail information of the task list, the first subscription rule including a recipient of the second detail information; the recipient including a single contact and/or a group, and the second detail information including progress information of target tasks in the task list; and
pushing the second detail information to the recipient based on the first subscription rule.

In a second aspect, the present application provides an information processing apparatus including:
a displaying unit configured to display, in response to an operation of a first user for viewing first detail information of a task list, a list detail page containing the first detail information, the first detail information including a list of tasks contained in the task list;
the displaying unit being further configured to display, in response to an operation of the first user for subscribing to the task list, a subscription panel, the subscription panel being configured for the first user to set a first subscription rule with respect to second detail information of the task list, the first subscription rule including a recipient of the second detail information; the recipient including a single contact and/or a group, and the second detail information including progress information of target tasks in the task list; and
a pushing unit configured to push the second detail information to the recipient based on the first subscription rule.

In a third aspect, the present application provides an electronic device including:
a processor; and
a memory configured to store executable instructions of the processor;
wherein the processor is configured to implement the method of the first aspect or any of various possible embodiments of the first aspects.

In a fourth aspect, the present application embodiments provides a computer readable storage medium having a computer program stored thereon, when executed by the processor, the computer program implements the method of the first aspect or any of various possible embodiments of the first aspects.

The present application provides a technical solution, including in response to an operation of a first user for viewing first detail information of a task list, displaying a list detail page containing the first detail information, the first detail information including a list of tasks contained in the task list; in response to an operation of the first user for subscribing to the task list, displaying a subscription panel, the subscription panel being configured for the first user to set a first subscription rule with respect to second detail information of the task list, the first subscription rule including a recipient of the second detail information; the recipient including a single contact and/or a group, and the second detail information including progress information of target tasks in the task list; and pushing the second detail information to the recipient based on the first subscription rule. According to the technical solution, the progress situation of a task within the list may be displayed on a list detail page, and the progress of a task within the list may be pushed to the recipient according to the set subscription rule, thereby avoiding the complicated operation of the user in viewing the progress of a specific task in the related art, saving the user's time, and improving the efficiency of the user in obtaining task information.

### BRIEF DESCRIPTION OF THE DRAWINGS

In order to more clearly illustrate the technical solutions in the embodiments of the present disclosures or prior art, the following will be a brief introduction to the accompanying drawings required for the description of the embodiments or the prior art. Obviously, the accompanying drawings in the following description relate to some embodiments of the present disclosure. For those of ordinary skill in the art, other drawings can be obtained according to these drawings without creative labor. In the drawings:

FIG. 1 is a schematic structural diagram of a system provided by an embodiment of the present application:

FIG. 2a is a flowchart diagram of an information processing method provided by an embodiment of the present application:

FIG. 2b is a schematic diagram of a page of a management platform provided by an embodiment of the present application:

FIG. 2c is a schematic diagram of display content for task completion situation provided by an embodiment of this application:

FIG. 2d is a schematic diagram of another page of a management platform provided by an embodiment of the present application:

FIG. 2e is a schematic diagram of a subscription panel provided by an embodiment of the present application:

FIG. 2f is another schematic diagram of a subscription panel provided by an embodiment of the present application:

FIG. 2g is another schematic diagram of a subscription panel provided by an embodiment of the present application:

FIG. 2h is another schematic diagram of a subscription panel provided by an embodiment of the present application:

FIG. 2i is another schematic diagram of a subscription panel provided by an embodiment of the present application:

FIG. 2j is a schematic diagram of display content for second detail information provided by an embodiment of the present application:

FIG. 2k is a schematic diagram of a conversation window of a target conversation group provided by an embodiment of the present application:

FIG. 2l is a schematic diagram of display content for second detail information provided by an embodiment of the present application:

FIG. 2m is a schematic diagram of a display location of a subscription panel provided by an embodiment of the present application:

FIG. 3 is a schematic structural diagram of an information processing apparatus provided by an embodiment of the present application:

FIG. 4 is a schematic structural diagram of an electronic device provided by an embodiment of the present application.

### DETAILED DESCRIPTION

The embodiments of the present application are described in detail below, and examples of the embodiments are shown in the drawings. The embodiments described below with reference to the accompanying drawings are exemplary and are intended to be used in the interpretation of the present application and are not to be construed as limiting the application.

The terms “first” and “second” in the specification of the embodiments of the present application, claims, and the accompanying drawings are used to distinguish similar objects but are not necessarily used to describe a particular order or sequence. It should be understood that the data so used may be interchangeable, where appropriate, so that the present technical solution may be implemented in another order other than that illustrated or described in the present application. In addition, the terms “including” and “having”, and any variations thereof, are intended to cover non-exclusive inclusion, e.g., a process, method, system, product, or apparatus that incorporates a series of steps or units need not be limited to those that are clearly listed, but may include other steps or units that are not clearly listed or that are inherent to those processes, methods, products, or devices.

In related art, in the use scenario of office software, when a user needs to view corresponding tasks in a list, the user needs to tap each task one by one to view the completion status of the tasks in the list as well as the deadlines, which is more complicated to operate and wastes too much time, and thus the efficiency of the user in obtaining information about the task is lower.

The technical solution of the present application and how the technical solution of the present application solves the above technical problems are described in detail though the specific embodiments below. The following specific embodiments may be combined with each other, and the same or similar concepts or processes may not be repeatedly described in some embodiments. The embodiments of the present application will be described below in conjunction with the accompanying drawings.

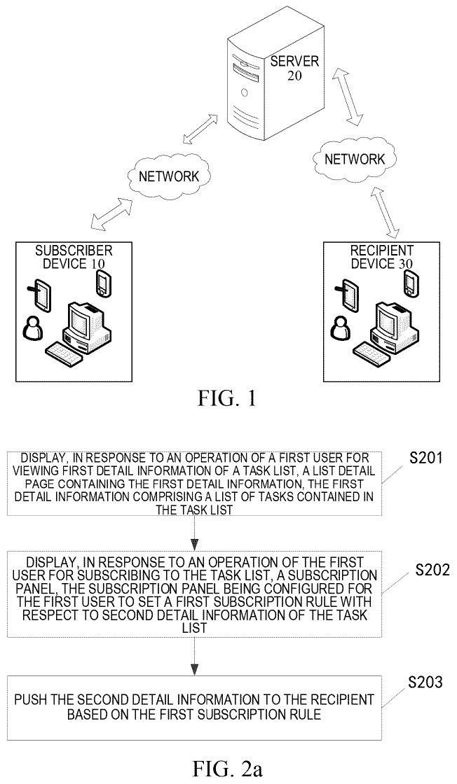

FIG. 1 is a schematic structural diagram of a system provided by an exemplary embodiment of the present application, the system including: a subscriber device 10, a server 20, and a recipient device 30, wherein:

The subscriber device 10 is configured for:
in response to an operation of a first user for viewing first detail information of a task list, displaying a list detail page containing the first detail information, the first detail information including a list of tasks contained in the task list;
in response to an operation of the first user for subscribing to the task list, displaying a subscription panel, the subscription panel being configured for the first user to set a first subscription rule with respect to second detail information of the task list, the first subscription rule including a recipient of the second detail information; the recipient including a single contact and/or a group, and the second detail information including progress information of target tasks in the task list; and
transmitting the first subscription rule and the second detail information to the server 20 such that the server 20 pushes the second detail information to the recipient device 30 based on the first subscription rule.

The recipient device 30 is configured for receiving and displaying the second detail information.

The execution principles and interaction processes of the constituent units in the present system embodiments can be found in the following descriptions of respective method embodiments.

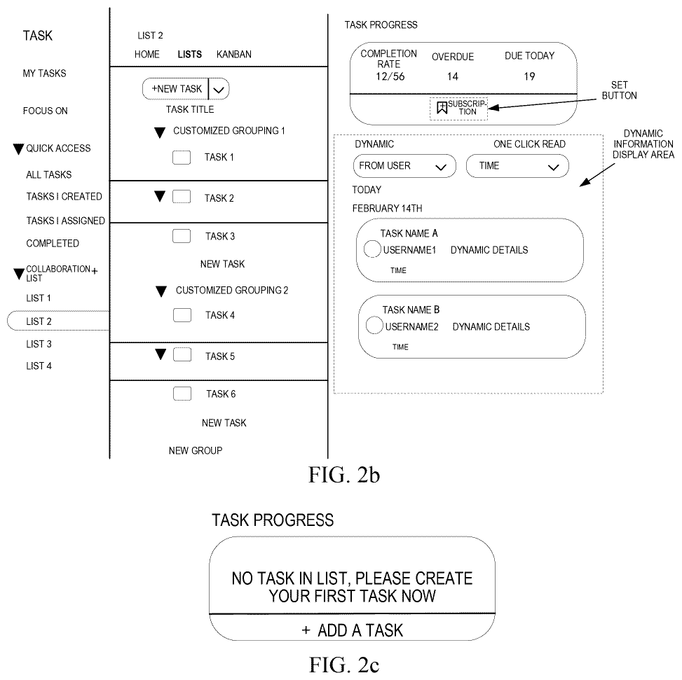

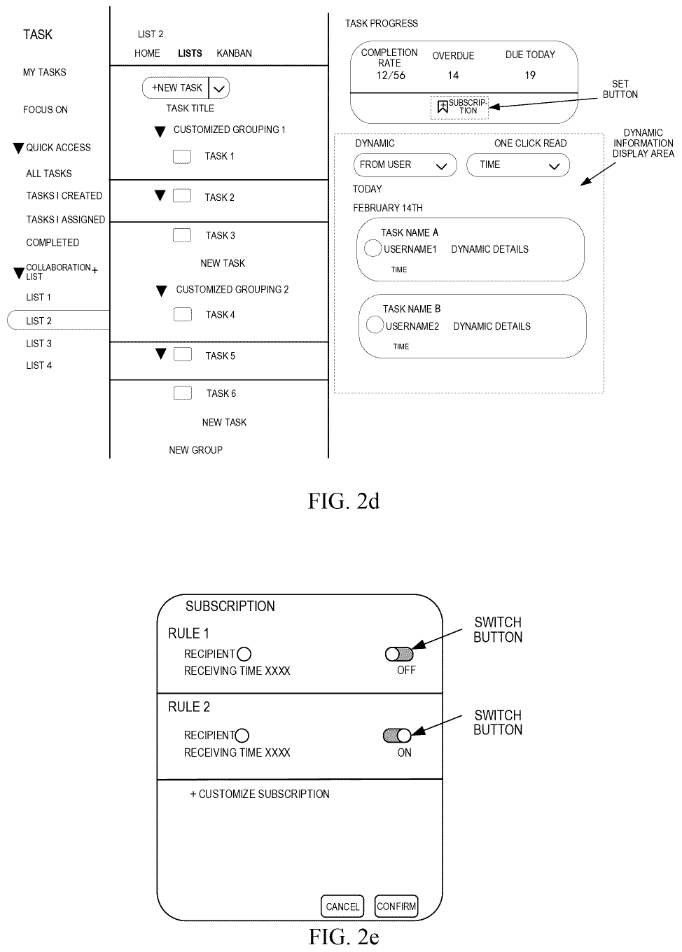

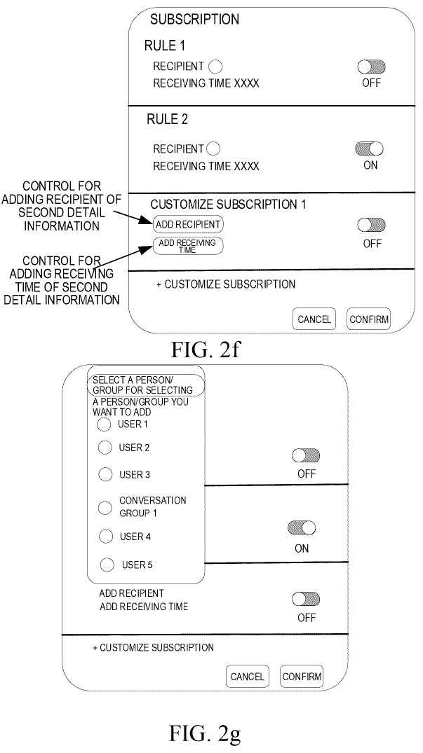

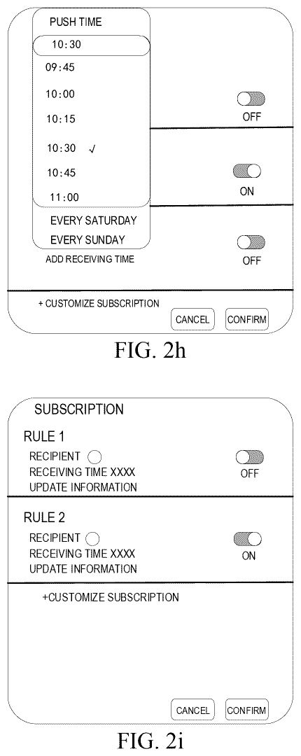

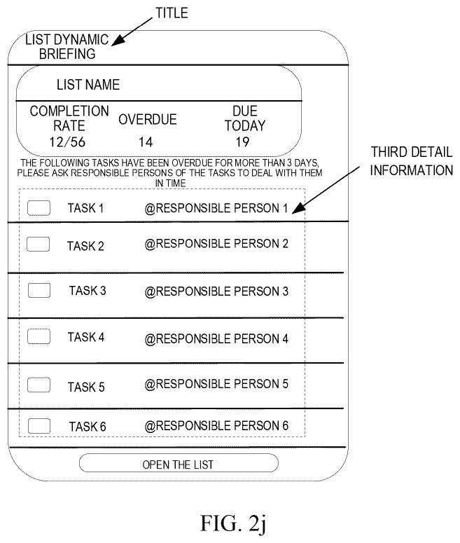

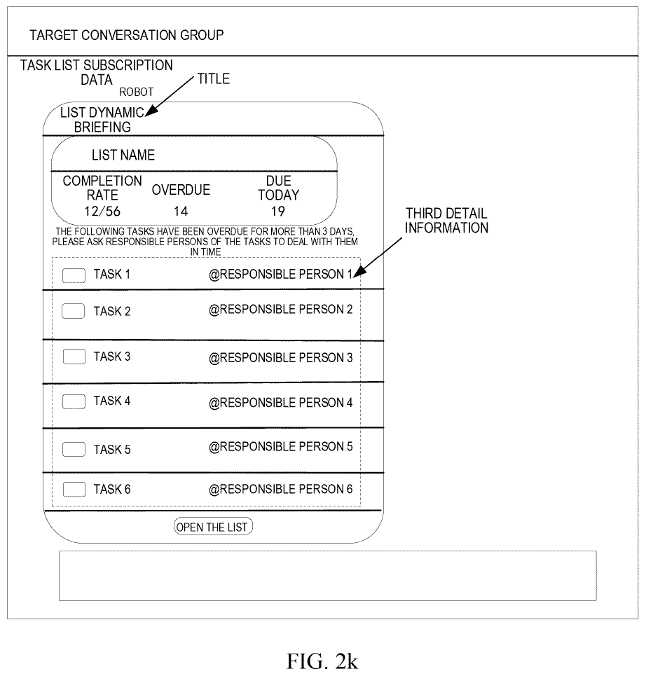

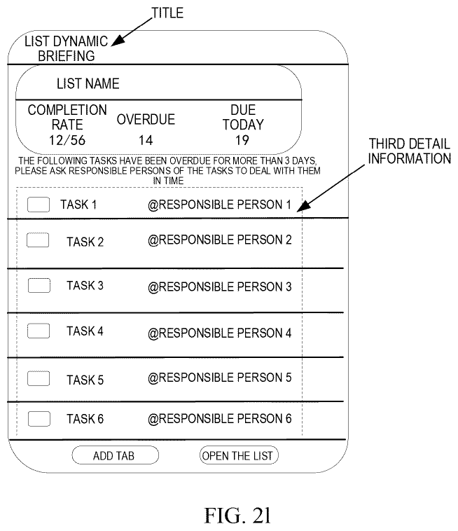

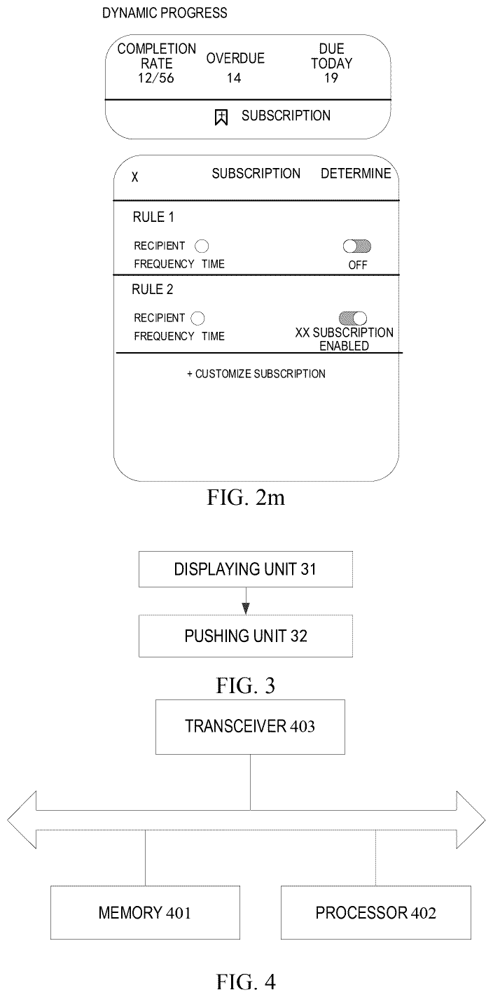

FIG. 2a illustrates a flowchart of an information processing method provided by an exemplary embodiment of the present application, which may be applicable to the above subscriber device 10, and specifically it may be applicable to a scenario of an enterprise collaboration and management platform. The method includes at least the following steps S201-S203:

S201, in response to an operation of a first user for viewing first detail information of a task list, displaying a list detail page containing the first detail information, the first detail information including a list of tasks contained in the task list;

In some embodiments, the operation for viewing the first detail information of the task list may refer to an operation of a user for clicking on a list name button of the task list on a task center page. The user may add tasks on a list detail page, where the tasks created on the list detail page are tasks contained in the task list, and the tasks may also be grouped by means of an associated grouping button, and subtasks of a task may also be created.

Specifically, as can be seen in FIG. 2b, when the user clicks on a button for list 2, the list detail page may be displayed with detail information of list 2.

In some embodiments, the task list in the present application may include a plurality of tasks, and the plurality of tasks may be completed by a plurality of persons, such as a plurality of persons may collaborate to complete the same task, or one task may be completed by a single person. For the task list, there may be collaborators, and the collaborators of the task list may view the task list, or may also create tasks, modify tasks, end tasks, delete tasks, and the like in the list of tasks.

In some embodiments, the task list in this application may also be referred to as a collaborative list. One of the pages in the management platform can be seen in FIG. 2b, and the user may tap the “+” on the right side of the “Collaboration List” button in FIG. 2b to create a task list, such as “List 1”. “List 2”, “List 3”, and “List 4” in FIG. 2b.

In some embodiments, the list detail page also includes a plurality of toggle buttons, and when the user clicks on different toggle buttons, the list of tasks within the list detail page is displayed in different formats. The toggle buttons may be: “Home”, “List”, and “Kanban” in FIG. 2b. When the user clicks on the toggle button “List”, the list of tasks can be displayed in the format shown in FIG. 2b.

The user may add new tasks by clicking the “+New Task” button in FIG. 2b, and the user may also group tasks.

Task 1″, “Task 2”, “Task 3”, “Task 4”, “Task 5”, “Task 6” in FIG. 2b are the task names.

In some embodiments, the list detail page further includes: progress of all tasks included in the task list.

In some embodiments, the progress of all tasks contained in the task list includes at least one of: a task completion rate, the task number of overdue tasks, a task number of tasks that are due on a current day;

The task completion rate may refer to a ratio of a task number of the completed tasks in all task contained in the task list to a task number of all tasks, which may be as “12/56” in FIG. 2b. Herein, 12 refers to the task number of the completed tasks and 56 refers to the task number of all tasks. “14” in FIG. 2b refers to the task number of the overdue tasks, and “19” in FIG. 2b refers to the task number of the tasks that are due on a current day.

In some embodiments, please refer to FIG. 2c, when there is not any task within the task list, “No task in list, please create your first task now” may be displayed in a display area for the progress of all the tasks contained in the task list.

In some embodiments, each of progress situations of all tasks contained in the task list may have its corresponding display manner, e.g., the color of the task completion rate is black, the color of the task number of the overdue tasks is red, and the color of the task number of the tasks that are duc on the current day is black.

In some embodiments, the progress of all tasks contained in the task list is correlated with the time zone of the current location.

In some embodiments, the counting of task number in the present application may include a first level of tasks and a second level of tasks under the task list, wherein the second level of tasks refers to subtasks of the first level of tasks.

In some embodiments, all levels of tasks under the task list are involved in counting the number of tasks, such as, a first level of tasks, a second level of tasks, a third level of tasks, a fourth level of tasks, a fifth level of tasks, etc., which is not limited in the present application. The third level of tasks are sub-tasks of the second level of tasks, the fourth level of tasks are sub-tasks of the third level of tasks, and the fifth level of tasks are sub-tasks of the fourth level of tasks.

In some embodiments, the tasks in the present application may include API tasks.

S202, in response to an operation of the first user for subscribing to the task list, displaying a subscription panel, the subscription panel being configured for the first user to set a first subscription rule with respect to second detail information of the task list, the first subscription rule including a recipient of the second detail information; the recipient including a single contact and/or a group, and the second detail information including progress information of target tasks in the task list;

In some embodiments, the operation of the first user subscribing to the task list may refer to an operation of the first user clicking a subscribe button on the list detail page.

In some other embodiments, the operation of the first user subscribing to the task list may be an operation of the first user subscribing to the task list on pop-up content when the first user hovers over the name of the task list through a mouse.

In some other embodiments, the operation of the first user subscribing to the task list may be an operation of the user right-clicking the task list and subscribing to the task list in a pop-up menu.

In some other embodiments, the first user may also subscribe to the task list at other positions.

In some embodiments, the target tasks are all of the tasks included in the task list. In other embodiments, the target tasks may also refer to a portion of tasks in the task list, which may be specified by the user.

In some embodiments, the progress information of the target task includes at least one of the following: a task completion rate of the target task, a task number of overdue tasks in the target tasks, a task number of tasks in the target tasks that are due on the current day.

In some optional embodiments, the first detail page is also displayed with dynamic information for the task list, as can be seen in the content displayed within a dynamic information display area in FIG. 2d. The dynamic information of the present application supports one-click read.

In some optional embodiments, the first detail page is also displayed with a dynamic filter control for the user to filter the display, specifically, the filter item may be a dynamic operation user, and dynamic operation time.

In some optional embodiments, the progress of all the tasks contained in the above task list and the subscribe button may be displayed on the same card.

The subscribe button may refer to a setting button for the first user to set the first subscription rule, as may be shown in FIG. 2d.

In some optional embodiments, the first subscription rule for the task list is visible to a first class of users and editable to a second class of users, or is visible and editable to both the first class of users and the second class of users; or, all subscription rules for the task list are visible to the first class of users and editable to the second class of users, or are visible and editable to both the first class of users and the second class of users. The first class of users includes all users having access permission to the task list, and the second class of users includes all users having editing permission to the task list. Here, the first class of users or the second class of users may not be collaborators of the task list but have gained permission to the list through special authorization.

In some optional embodiments, all subscription rules for the task list are visible and editable to all collaborators of the task list.

In the above embodiments, the solution that the subscription rules being visible and editable to a plurality of persons (all collaborators of the list or all editable users, etc.) facilitates sharing of subscription rules between users and thus improves work efficiency. For example, one user who sees a rule created by another user may directly subscribe to the rule or add other recipients to the rule as needed, without having to recreate the subscription rule himself. In addition, when a user A is transferred or is no longer involved in processing the task list by another work arrangement, other users may modify and delete the subscription rule created by user A, thus avoiding problems caused due to that the subscription rule cannot be deleted when the subscription rule is no longer needed.

In some optional embodiments, an editing operation on a subscription rule includes at least one of: creating a subscription rule, deleting a subscription rule, modifying a subscription rule.

In some embodiments, in response to an operation of a second user for subscribing to the first subscription rule, the second user is added to recipients of the first subscription rule. The second user was not a recipient of the first subscription rule originally.

In some embodiments, in response to an operation of a third user unsubscribing from the first subscription rule, the third user is removed from the recipients of the first subscription rule. The third user is originally a recipient of said first subscription rule.

In some embodiments, the first subscription rule further includes: time for pushing the second detail information to the recipient. For example, pushing may be performed every Monday at 9:00 am. Alternatively, pushing may be performed when a predetermined condition is met, the predetermined condition may include a task completion rate of 50%, and so on.

In some optional embodiments, the subscription panel is displayed with an add button for the first user to set the first subscription rule; accordingly, the method further includes:
S21, in response to an operation of the first user on the add button, displaying an operable control for the first user to set the first subscription rule;
S22, in response to an operation of the first user on the operable control, determining the first subscription rule.

In some embodiments, FIG. 2e is a schematic diagram of a page of a subscription panel provided by an exemplary embodiment of the present application, and the add button is the “+Customize Subscription” button of FIG. 2c.

In some embodiments, the method further includes: displaying a name of the first subscription rule on a display page of the operable control, wherein the first subscription rule has a default name: “Customize Subscription 1” (as shown in FIG. 2f), and the name of the first subscription rule can be edited and changed by a user having editing permission to the task list.

In some embodiments, the operable control specifically includes: a control for a user to add a recipient of the second detail information, and a control for a user to add receiving time of the second detail information, as may be shown in FIG. 2f.

When the user clicks the control for a user to add a recipient of the second detail information, a drop-down menu for displaying an optional recipient of the second detail information may be triggered, which may be shown in FIG. 2g, wherein “user 1”, “user 2”, “user 3”, “conversation group 1”, “user 4”, and “user 5” refer to the optional recipients of the second detail information.

When the user clicks the control for a user to add receiving time of the second detail information, a drop-down menu for displaying optional receiving time of the second detail information may be triggered, which may be shown in FIG. 2h, wherein the optional receiving time of the second detail information may include an optional repeated push date of the second detail information, and an optional push time. The “09:45”, “10:00”, “10:15”, “10:30”, “10:45”, “11:00” in FIG. 2h are optional push time of the second detail information. Optionally, the optional push time of the second detail information may be accurate to a minute in 0:00-24:00. The optional repeated push date of the second detail information may be “every Monday”, “every Tuesday”, “every Wednesday”, “every Thursday”, “every Friday”, “every Saturday”, or “every Sunday”.

In other optional embodiments, the operation for viewing the first detail information of the list may further refer to an operation of a user for viewing the first detail information of the list within a conversation window. At the same time, a user or a conversation group corresponding to the conversation window is ranked ahead of the other optional recipients of the second detail information among the optional recipients of the second detail information.

In some embodiments, among the other optional recipients of the second detail information, the conversation group having an association with the list ranks ahead of the other optional recipients of the second detail information.

In some embodiments, a collaborator list for the task list is displayed last among the other optional recipients of the second detail information.

In some embodiments, in addition to the first subscription rule, the subscription panel displays at least one of the following:
a switch button for the first user to set whether or not to enable a function of pushing the second detail information to the recipient based on the first subscription rule;
a subscription rule other than the first subscription rule.

Specifically, the switch button may be indicated in FIG. 2e, and the other subscription rules may be indicated as Rule 1 & Rule 2 in FIG. 2f.

When the switch button is in an on state, the function of pushing the second detail information to the recipient based on the first subscription rule is effective immediately, and when the switch button is not in the on state, the function of pushing the second detail information to the recipient based on said first subscription rule is not effective.

In some embodiments, a setter of the other subscription rule may be the first user or another user, and another user may be a collaborator of the task list, etc.

In some other embodiments, the setter of the other subscription rules may also be another user who has permission to add subscription rules, which is not limited in the present application. The permission to add subscription rules may be set by a person in charge of the list.

In some embodiments, the subscription panel is further displayed with a predetermined subscription rule, wherein the predetermined subscription rule is a subscription rule automatically generated by the system when the task list is created, and a recipient corresponding to the predetermined subscription rule is a creator of the task list, and the push time corresponding to the predetermined subscription rule may be 9:00 a.m. every weekday.

In some embodiments, the method further includes: displaying an operation record for the subscription rule of the task list in a dynamic information display page for the task list;
and/or,
displaying an operation record for the subscription rule of the task list in a dynamic information display page of a task center.

The operation record includes at least one of the following: creating a subscription rule, deleting a subscription rule, and modifying a subscription rule.

In some embodiments, the operation record further includes enabling the subscription rule.

In some embodiments, the dynamic information display page of the task center is a display page for displaying dynamic information of global dynamics.

FIG. 2i is another schematic diagram of a page of another subscription panel provided by an example embodiment of the application. As shown in FIG. 2i, the subscription panel further display information about the latest editing operation record corresponding to respective subscription rules in the task list, which is provided under the receiving time of the corresponding subscription rule.

For example, if the latest editing operation for the first subscription rule is that Xiaoming sets a switch button, which is configured for setting whether or not enabling a function of pushing the second detail information to the recipient based on the first subscription rule, to be on, and the operation time is February 2 this year, then the latest editing operation record information corresponding to the first subscription rule may be specific as follows: Xiaoming enabled the subscription on February 2; when the operation time is not this year, the latest editing operation record information corresponding to the first subscription rule also includes the year corresponding to the operation time, for example, when the operation time is Feb. 2, 2022, the latest editing operation record information corresponding to the first subscription rule may be specified as: Xiaoming enabled the subscription on Feb. 2, 2022.

S203, pushing the second detail information to the recipient based on the first subscription rule;

In some optional embodiments, the second detail information further includes at least one of the following: a pusher of the first subscription rule, a push date, a title.

Optionally, the pusher of the first subscription rule may be the creator of the first subscription rule, or a robot.

In some embodiments, the second detail information further includes at least one of the following: a list name of the task list; third detail information of overdue tasks in the target tasks, which may be shown in FIG. 2j.

The third detail information may include at least one of the following: names of overdue tasks, length of time each overdue task has been overdue, and persons in charge of the overdue tasks. When displaying the third detail information, the person in charge of the overdue task may be notified by @.

In some embodiments, when pushing the second detail information to the recipient based on the first subscription rule, the second detail information may be pushed to the recipient in a form of a notification.

In other embodiments, when pushing the second detail information to the recipient based on the first subscription rule, the second detail information may be pushed to the recipient as a conversation message, e.g., when the recipient is a target conversation group as described above, the second detail information may be pushed to the target conversation group as a conversation message, i.e., displayed in a conversation window of the target conversation group, as may be seen in FIG. 2k.

In some embodiments, the method further includes: displaying a corresponding task when a user clicking on the progress of a target task is detected, the progress may be, for example, a task completion rate of the target task, or task number of overdue tasks in the target tasks, a task number of tasks in the target tasks that are due on the current day.

In some embodiments, the method further includes:
in response to an operation of the first user associating the task list with the target conversation group, creating an association between the task list and the target conversation group.

In some embodiments, the specific operation of the first user associating the task list with the target conversation group may specifically be: the first user binding the task list with the target conversation group. Group members in the target conversation group may view the task list in the target conversation group.

In some embodiments, if a target conversation group is a recipient of the second detail information, in a case that the task list has an association with the target conversation group, when a group member within the target conversation group views the first detail information based on the second detail information, the first detail information is displayed in a display manner different from that for displaying the first detail information when the group member views the first detail information based on the second detail information, in a case that the task list does not has an association with the target conversation group.

In some embodiments, the display manners being different includes when the task list has an association with the target conversation group, displaying the first detail information within a conversation window when the group member within the target conversation group views the first detail information based on the second detail information; and when the task list does not has an association with the target conversation group, displaying the first detail information in a separate page other than the conversation window when the group member views the first detail information based on the second detail information.

In some embodiments, as shown in FIGS. 2J and 2K, a group member may view the first detail information by clicking on an “open list” button in the second detail information.

In some optional embodiments, the group members may also create an association between the task list and the target conversation group, and the user may create an association between the task list and the target conversation group by using the corresponding association creation button. Optionally, the user may open the association creation page by clicking the “Add Tab” button in FIG. 2L to create an association between the task list and the target conversation group.

In some embodiments, the above subscription panel may be displayed below the progress of all tasks in the task list, as may be shown in FIG. 2m.

In some embodiments, the subscription panel in the present application may be overlayed in the form of a pop-up window on top of the first detail information.

The present application provides a technical solution, including in response to an operation of a first user for viewing first detail information of a task list, displaying a list detail page containing the first detail information, the first detail information including a list of tasks contained in the task list; in response to an operation of the first user for subscribing to the task list, displaying a subscription panel, the subscription panel being configured for the first user to set a first subscription rule with respect to second detail information of the task list, the first subscription rule including a recipient of the second detail information; the recipient including a single contact and/or a group, and the second detail information including progress information of target tasks in the task list; and pushing the second detail information to the recipient based on the first subscription rule. According to the technical solution, the progress situation of a task within the list may be displayed on a list detail page, and the progress of a task within the list may be pushed to the recipient according to the set subscription rule, thereby avoiding the complicated operation of the user in viewing the progress of a specific task in the related art, saving the user's time, and improving the efficiency of the user in obtaining task information.

FIG. 3 illustrates a schematic structural diagram of an information processing apparatus provided by an exemplary embodiment of the present application.

The apparatus includes:
a displaying unit 31 configured to display, in response to an operation of a first user for viewing first detail information of a task list, a list detail page containing the first detail information, the first detail information comprising a list of tasks contained in the task list;
the displaying unit 31 being further configured to display, in response to an operation of the first user for subscribing to the task list, a subscription panel, the subscription panel being configured for the first user to set a first subscription rule with respect to second detail information of the task list, the first subscription rule comprising a recipient of the second detail information; the recipient comprising a single contact and/or a group, and the second detail information comprising progress information of target tasks in the task list; and
a pushing unit 32 configured to push the second detail information to the recipient based on the first subscription rule.

Optionally, the first subscription rule for the task list is visible to a first class of users and being editable to a second class of users, or is visible and editable to both the first class of users and the second class of users;

Or, all subscription rules for the task list are visible to the first class of users and being editable to the second class of users, or are visible and editable to both the first class of users and the second class of users.

Optionally, all subscription rules for the task list being visible and editable to all collaborators of the task list.

Optionally, an editing operation on a subscription rule includes at least one of: creating a subscription rule, deleting a subscription rule, modifying a subscription rule.

Optionally, the apparatus is further configured to: add, in response to an operation of a second user for subscribing to the first subscription rule, the second user to recipients of the first subscription rule;

Alternatively,
in response to an operation of a third user unsubscribing from the first subscription rule, remove the third user from recipients of the first subscription rule.

Optionally, the first subscription rule further includes: time for pushing the second detail information to the recipient.

Optionally, the apparatus is further configured to display an operation record for the subscription rule of the task list in a dynamic information display page for the task list;
and/or.
display an operation record for the subscription rule of the task list in a dynamic information display page of a task center.

Optionally, the progress information of the target tasks comprises at least one of the following: a task completion rate of the target tasks, a task number of overdue tasks in the target tasks, a task number of tasks in the target tasks that are due on a current day;
and/or.
the second detail information further comprises at least one of the following: a list name of the task list; third detail information of overdue tasks in the target tasks.

Optionally, in addition to the first subscription rule, the subscription panel further displays at least one of the following:
a switch button for the first user to set whether or not to enable a function of pushing the second detail information to the recipient based on the first subscription rule;
a subscription rule other than the first subscription rule.

Optionally, if a target conversation group is a recipient of the second detail information, in a case that the task list has an association with the target conversation group, when a group member within the target conversation group views the first detail information based on the second detail information, the first detail information is displayed in a display manner different from that for displaying the first detail information when the group member views the first detail information based on the second detail information, in a case that the task list does not has an association with the target conversation group.

It should be understood that the apparatus embodiments and method embodiments may correspond to each other, and reference may be made to the method embodiments for similar description. In order to avoid repetition, it will not be repeated herein. Specifically, the apparatus may perform the above method embodiments, and the foregoing and other operations and/or functions of the various modules in the apparatus are corresponding processes in the various methods in the above method embodiments, respectively, and will not be repeated herein for the sake of brevity.

The apparatus of the present application embodiments is described above in connection with the accompanying drawings from the perspective of functional modules. It should be understood that the functional modules may be implemented in the form of hardware, in the form of instructions of software, or in a combination of hardware and software modules. Specifically, the steps of the method embodiments of the present application embodiments may be accomplished by integrated logic circuits of hardware in a processor and/or instructions in the form of software, and the steps of the method embodiments disclosed in the present application embodiments may be directly embodied as accomplished by execution of a hardware decoder processor or accomplished by execution with a combination of hardware and software modules in a decoder processor. Optionally, the software module may be located in random memory, flash memory, read-only memory, programmable read-only memory, electrically erasable programmable memory, registers, and other storage media well established in the art. The storage medium is located in a memory, and the processor reads the information in the memory, in combination with its hardware to accomplish the steps in the method embodiments described above.

FIG. 4 is a schematic block diagram of an electronic device provided by the embodiments of this application, which may include:
a memory 401 and a processor 402, wherein the memory 401 is configured to store a computer program and transmit the program code to the processor 402. In other words, the processor 402 may call the computer program from the memory 401 and run the computer program to implement the methods in the embodiments of the present application.

For example, this processor 402 may be configured to execute the method embodiments described above according to instructions in this computer program.

In some embodiments of the present application, the processor 402 may include, but is not limited to:
general purpose processors, Digital Signal Processors (DSPs), Application Specific Integrated Circuits (ASICs), Field Programmable Gate Arrays (FPGAs) or other programmable logic devices, discrete gate or transistor logic devices, discrete hardware components, and the like.

In some embodiments of the present application, the memory 401 includes, but is not limited to:
a volatile memory and/or a non-volatile memory. The non-volatile memory may be Read-Only Memory (ROM), Programmable Read-Only Memory (PROM), Erasable Programmable Read-Only Memory (EPROM), Electrically Erasable Programmable Read-Only Memory (EEPROM), or flash memory. The volatile memory can be Random Access Memory (RAM), which is configured as an external cache. By way of illustration, but not limitation, many types of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchronous Link DRAM (SLDRAM), and Direct Rambus Random Access Memory (DR RAM).

In some embodiments of the present application, the computer program may be partitioned into one or more modules, the one or more modules are stored in the memory 401 and executed by the processor 402 to accomplish the methods provided herein. The one or more modules may be a series of computer program instruction segments capable of accomplishing a particular function, which instruction segments are configured to describe an execution process of the computer program in the electronic device.

As shown in FIG. 4, the electronic device may also include:
a transceiver 403, and the transceiver 403 may be connected to the processor 402 or memory 401.

The processor 402 may control the transceiver 403 to communicate with other devices, specifically, the transceiver may transmit information or data to other devices, or receive information or data transmitted by other devices. The transceiver 403 may include a transmitter and a receiver. The transceiver 403 may further include an antenna, and the number of antennas may be one or more.

It should be understood that the various components in the electronic device are connected via a bus system, wherein in addition to a data bus, the bus system further includes a power bus, a control bus, and a state signal bus.

The present application also provides a computer storage medium having stored thereon a computer program which, when being executed by a computer, causes the computer to implement the method embodiments described above. Alternatively, the present application embodiments also provide a computer program product including instructions which, when executed by a computer, causes the computer to implement the method embodiments described above.

When implemented using software, it may be implemented in whole or in part as a computer program product. The computer program product comprises one or more computer instructions. When loading and executing the computer program instructions on the computer, all or part of the instructions provide a function of the flow in accordance with the present application. The computer may be a general-purpose computer, a specialized computer, a computer network, or other programmable device. The computer instructions may be stored in a computer readable storage medium or transmitted from one computer readable storage medium to another computer readable storage medium, e.g., the computer instructions may be transmitted from one web site, computer, server, or data center to another web site, computer, server, or data center via wired (e.g., coaxial cable, fiber optics, digital subscriber line (DSL)) or wireless (e.g., infrared, wireless, microwave, etc.) means. The computer readable storage medium may be any usable medium that a computer may access or a data storage device such as a server, data center, etc. integrated with one or more usable media. The usable medium may be a magnetic medium (e.g., floppy disk, hard disk, tape), an optical medium (e.g., digital video disc (DVD)), or a semiconductor medium (e.g., solid state disk (SSD)), and the like.

According to one or more embodiments of the present application, there is provided an information processing method including:
in response to an operation of a first user for viewing first detail information of a task list, displaying a list detail page containing the first detail information, the first detail information including a list of tasks contained in the task list;
in response to an operation of the first user for subscribing to the task list, displaying a subscription panel, the subscription panel being configured for the first user to set a first subscription rule with respect to second detail information of the task list, the first subscription rule including a recipient of the second detail information; the recipient comprising a single contact and/or a group, and the second detail information including progress information of target tasks in the task list; and
pushing the second detail information to the recipient based on the first subscription rule.

According to one or more embodiments of the present application, the method further includes:
the first subscription rule for the task list being visible to a first class of users and being editable to a second class of users, or being visible and editable to both the first class of users and the second class of users;
or, all subscription rules for the task list being visible to the first class of users and being editable to the second class of users, or being visible and editable to both the first class of users and the second class of users.

According to one or more embodiments of the present application, the method further includes:
all subscription rules for the task list being visible and editable to all collaborators of the task list.

According to one or more embodiments of the present application, an editing operation on a subscription rule includes at least one of: creating a subscription rule, deleting a subscription rule, modifying a subscription rule.

According to one or more embodiments of the present application, the method further includes:
in response to an operation of a second user for subscribing to the first subscription rule, adding the second user to recipients of the first subscription rule;
or.
in response to an operation of a third user unsubscribing from the first subscription rule, removing the third user from recipients of the first subscription rule.

According to one or more embodiments of the present application, the method further includes:
the first subscription rule further includes: time for pushing the second detail information to the recipient.

According to one or more embodiments of the present application, the method further includes:
displaying an operation record for the subscription rule of the task list in a dynamic information display page for the task list;
and/or,
displaying an operation record for the subscription rule of the task list in a dynamic information display page of a task center.

According to one or more embodiments of the present application, the progress information of the target tasks comprises at least one of the following: a task completion rate of the target tasks, a task number of overdue tasks in the target tasks, a task number of tasks in the target tasks that are due on a current day;
and/or,
the second detail information further comprises at least one of the following: a list name of the task list; third detail information of overdue tasks in the target tasks.

According to one or more embodiments of the present application, in addition to the first subscription rule, the subscription panel further displays at least one of the following:
a switch button for the first user to set whether or not to enable a function of pushing the second detail information to the recipient based on the first subscription rule;
a subscription rule other than the first subscription rule.

According to one or more embodiments of the present application, if a target conversation group is a recipient of the second detail information, in a case that the task list has an association with the target conversation group, when a group member within the target conversation group views the first detail information based on the second detail information, the first detail information is displayed in a display manner different from that for displaying the first detail information when the group member views the first detail information based on the second detail information, in a case that the task list does not has an association with the target conversation group.

According to one or more embodiments of the present application, the display manners being different includes:

when the task list has an association with the target conversation group, displaying the first detail information within a conversation window when the group member within the target conversation group views the first detail information based on the second detail information; and when the task list does not has an association with the target conversation group, displaying the first detail information in a separate page other than the conversation window when the group member views the first detail information based on the second detail information.

According to one or more embodiments of the present application, the present application further provides an information processing unit including:
a displaying unit configured to display, in response to an operation of a first user for viewing first detail information of a task list, a list detail page containing the first detail information, the first detail information comprising a list of tasks contained in the task list;
the displaying unit being further configured to display, in response to an operation of the first user for subscribing to the task list, a subscription panel, the subscription panel being configured for the first user to set a first subscription rule with respect to second detail information of the task list, the first subscription rule comprising a recipient of the second detail information; the recipient comprising a single contact and/or a group, and the second detail information comprising progress information of target tasks in the task list; and
a pushing unit configured to push the second detail information to the recipient based on the first subscription rule.

According to one or more embodiments of the present application, the first subscription rule for the task list being visible to a first class of users and being editable to a second class of users, or being visible and editable to both the first class of users and the second class of users;
or, all subscription rules for the task list being visible to the first class of users and being editable to the second class of users, or being visible and editable to both the first class of users and the second class of users.

According to one or more embodiments of the present application, all subscription rules for the task list being visible and editable to all collaborators of the task list.

According to one or more embodiments of the present application, an editing operation on a subscription rule includes at least one of: creating a subscription rule, deleting a subscription rule, modifying a subscription rule.

According to one or more embodiments of the present application, the apparatus is further configured to:
in response to an operation of a second user for subscribing to the first subscription rule, add the second user to recipients of the first subscription rule;
or.
in response to an operation of a third user unsubscribing from the first subscription rule, remove the third user from recipients of the first subscription rule.

According to one or more embodiments of the present application, the first subscription rule further includes: time for pushing the second detail information to the recipient.

According to one or more embodiments of the present application, the apparatus is further configured to: display an operation record for the subscription rule of the task list in a dynamic information display page for the task list;
and/or,
display an operation record for the subscription rule of the task list in a dynamic information display page of a task center.

According to one or more embodiments of the present application, the progress information of the target tasks comprises at least one of the following: a task completion rate of the target tasks, a task number of overdue tasks in the target tasks, a task number of tasks in the target tasks that are due on a current day;
and/or,
the second detail information further comprises at least one of the following: a list name of the task list; third detail information of overdue tasks in the target tasks.

According to one or more embodiments of the present application, in addition to the first subscription rule, the subscription panel further displays at least one of the following:
a switch button for the first user to set whether or not to enable a function of pushing the second detail information to the recipient based on the first subscription rule;
a subscription rule other than the first subscription rule.

According to one or more embodiments of the present application, the apparatus is further configured to: if a target conversation group is a recipient of the second detail information, in a case that the task list has an association with the target conversation group, when a group member within the target conversation group views the first detail information based on the second detail information, displaying the first detail information in a display manner different from that for displaying the first detail information when the group member views the first detail information based on the second detail information, in a case that the task list does not has an association with the target conversation group.

According to one or more embodiments of the present application, the present application further provides an electronic device including:
a processor; and
a memory configured to store executable instructions of the processor;
wherein the processor is configured to implement each of the foregoing methods by executing the executable instructions.

In accordance with one or more embodiments of the present application, the present application further provides a computer readable storage medium having a computer program stored thereon, the computer program implements each of the foregoing methods when executed by a processor.

Those skilled in the art may realize that the modules and algorithmic steps of the various examples described in conjunction with the embodiments disclosed herein are capable of being implemented in electronic hardware, or a combination of computer software and electronic hardware. Whether these functions are performed in hardware or software depends on the particular application and design constraints of the technical solution. Those skilled in the art may use different methods for each particular application to realize the described functions, but such realization should not be considered beyond the scope of this application.

In the several embodiments provided in this application, it should be understood that the systems, apparatuses, and methods disclosed, may be realized in other ways. For example, the apparatus embodiments described above are merely schematic, e.g., the division of the module is merely a logical functional division, it may be divided in other ways when actually implemented, e.g., a plurality of modules or components may be combined or may be integrated into another system, or some features may be omitted, or not implemented. Besides, the mutual coupling or direct coupling or communication connection shown or discussed may be an indirect coupling or communication connection through some interface, device or module, which may be electrical, mechanical or otherwise.

The modules illustrated as separate components may or may not be physically separated, and the components shown as modules may or may not be physical modules, i.e., they may be located in one place or may also be distributed over a plurality of network units. Some or all of these modules may be selected to implement the purpose of the present embodiments according to actual needs. For example, various functional modules in the various embodiments of the present application may be integrated in a single processing module, or the individual modules may be physically present separately, or two or more modules may be integrated in a single module.

The above is only the detailed description of the present application, but the scope of protection of the present application is not limited thereto, and any skilled person familiar with the art can easily think of variations or substitutions within the scope of the technology disclosed in the present application, which shall be covered by the scope of protection of the present application. Therefore, the scope of protection of this application shall be subject to the scope of protection of the claims.

What is claimed is:

1. An information processing method, comprising:
in response to an operation of a first user for viewing first detail information of a task list, displaying a list detail page containing the first detail information, the first detail information comprising a list of tasks contained in the task list;
in response to an operation of the first user for subscribing to the task list, displaying a subscription panel, the subscription panel being configured for the first user to set a first subscription rule with respect to second detail information of the task list, the first subscription rule comprising a recipient of the second detail information; the recipient comprising a single contact and/or a group, and the second detail information comprising progress information of target tasks in the task list; and
pushing the second detail information to the recipient based on the first subscription rule.

2. The method of claim 1, wherein the method further comprises:
the first subscription rule for the task list being visible to a first class of users and being editable to a second class of users, or being visible and editable to both the first class of users and the second class of users;
or, all subscription rules for the task list being visible to the first class of users and being editable to the second class of users, or being visible and editable to both the first class of users and the second class of users.

3. The method of claim 1, wherein the method further comprises:
all subscription rules for the task list being visible and editable to all collaborators of the task list.

4. The method of claim 2, wherein an editing operation on a subscription rule comprises at least one of: creating a subscription rule, deleting a subscription rule, modifying a subscription rule.

5. The method of claim 1, wherein the method further comprises:
in response to an operation of a second user for subscribing to the first subscription rule, adding the second user to recipients of the first subscription rule;
or,
in response to an operation of a third user unsubscribing from the first subscription rule, removing the third user from recipients of the first subscription rule.

6. The method of claim 1, wherein the first subscription rule further comprises: time for pushing the second detail information to the recipient.

7. The method of claim 1, wherein the method further comprises:
displaying an operation record for the subscription rule of the task list in a dynamic information display page for the task list;
and/or,
displaying an operation record for the subscription rule of the task list in a dynamic information display page of a task center.

8. The method of claim 1, wherein
the progress information of the target tasks comprises at least one of the following: a task completion rate of the target tasks, a task number of overdue tasks in the target tasks, a task number of tasks in the target tasks that are due on a current day;
and/or,
the second detail information further comprises at least one of the following: a list name of the task list; third detail information of overdue tasks in the target tasks.

9. The method of claim 1, wherein in addition to the first subscription rule, the subscription panel further displays at least one of the following:
a switch button for the first user to set whether or not to enable a function of pushing the second detail information to the recipient based on the first subscription rule;
a subscription rule other than the first subscription rule.

10. The method of claim 1, wherein if a target conversation group is a recipient of the second detail information, in a case that the task list has an association with the target conversation group, when a group member within the target conversation group views the first detail information based on the second detail information, the first detail information is displayed in a display manner different from that for displaying the first detail information when the group member views the first detail information based on the second detail information, in a case that the task list does not has an association with the target conversation group.

11. The method of claim 10, wherein the display manners being different comprises:
when the task list has an association with the target conversation group, displaying the first detail information within a conversation window when the group member within the target conversation group views the first detail information based on the second detail information; and when the task list does not has an association with the target conversation group, displaying the first detail information in a separate page other than the conversation window when the group member views the first detail information based on the second detail information.

12. (canceled)

13. An electronic device, comprising:
a processor; and
a memory configured to store executable instructions of the processor;
wherein the processor is configured to implement acts comprising:
in response to an operation of a first user for viewing first detail information of a task list, displaying a list detail page containing the first detail information, the first detail information comprising a list of tasks contained in the task list;
in response to an operation of the first user for subscribing to the task list, displaying a subscription panel, the subscription panel being configured for the first user to set a first subscription rule with respect to second detail information of the task list, the first subscription rule comprising a recipient of the second detail information; the recipient comprising a single contact and/or a group, and the second detail information comprising progress information of target tasks in the task list; and
pushing the second detail information to the recipient based on the first subscription rule.

14. (canceled)

15. The device of claim 13, wherein the acts further comprise:
the first subscription rule for the task list being visible to a first class of users and being editable to a second class of users, or being visible and editable to both the first class of users and the second class of users;
or, all subscription rules for the task list being visible to the first class of users and being editable to the second class of users, or being visible and editable to both the first class of users and the second class of users.

16. The device of claim 15, wherein the acts further comprise:
all subscription rules for the task list being visible and editable to all collaborators of the task list.

17. The device of claim 15, wherein an editing operation on a subscription rule comprises at least one of: creating a subscription rule, deleting a subscription rule, modifying a subscription rule.

18. The device of claim 13, wherein the acts further comprise:
in response to an operation of a second user for subscribing to the first subscription rule, adding the second user to recipients of the first subscription rule;
or,
in response to an operation of a third user unsubscribing from the first subscription rule, removing the third user from recipients of the first subscription rule.

19. The device of claim 13, wherein the first subscription rule further comprises: time for pushing the second detail information to the recipient.

20. The device of claim 13, wherein the acts further comprise:
displaying an operation record for the subscription rule of the task list in a dynamic information display page for the task list;
and/or,
displaying an operation record for the subscription rule of the task list in a dynamic information display page of a task center.

21. The device of claim 13, wherein
the progress information of the target tasks comprises at least one of the following: a task completion rate of the target tasks, a task number of overdue tasks in the target tasks, a task number of tasks in the target tasks that are due on a current day;
and/or,
the second detail information further comprises at least one of the following: a list name of the task list; third detail information of overdue tasks in the target tasks.

22. A non-transitory computer readable storage medium having a computer program stored thereon, wherein, when being executed by the processor, the computer program implements acts comprising:
in response to an operation of a first user for viewing first detail information of a task list, displaying a list detail page containing the first detail information, the first detail information comprising a list of tasks contained in the task list;
in response to an operation of the first user for subscribing to the task list, displaying a subscription panel, the subscription panel being configured for the first user to set a first subscription rule with respect to second detail information of the task list, the first subscription rule comprising a recipient of the second detail information; the recipient comprising a single contact and/or a group, and the second detail information comprising progress information of target tasks in the task list; and
pushing the second detail information to the recipient based on the first subscription rule.
